(19) United States
(12) Patent Application Publication
(10) Pub. No.: US 2018/0062362 A1
(43) Pub. Date: Mar. 1, 2018

(54) Device and Method for Stripping Insulation from Flat-Bundled Wire

(71) Applicant: Robert Leslie Muston, Chewton (AU)

(72) Inventor: Robert Leslie Muston, Chewton (AU)

(21) Appl. No.: 15/557,495

(22) PCT Filed: Mar. 11, 2016
(86) PCT No.: PCT/AU2016/000083

§ 371 Date: Sep. 12, 2017

(30) Foreign Application Priority Data
Mar. 12, 2015 (AU) 2015201296

(51) Int. Cl. H02G 1/12; B25F 3/00

(52) U.S. Cl. CPC H02G 1/1256; B25F 3/00

(57) ABSTRACT

A device (2) for stripping insulation means (35) from flat-bundled wire means (22), the device (2) including a first jaw assembly (10), wherein the first jaw assembly (10) clamps the insulation means (35) at a clamping or penetrating region (39) of the insulation means (35), the first jaw assembly (10) including blade means (13, 15) for penetrating and/or weakening the insulation means (35) at said clamping or penetrating region (39), wherein part of the insulation means (35) is removed by relative movement between a gripped portion (41) of the insulation means (39) by a member (6) and the blade means (13, 15) when the blade means (13, 15) is in contact with the insulation means (35).

### FIELD OF THE INVENTION

This invention relates to a device and method for stripping insulation from flat-bundled wire, individually or formed as part of a power tool, and more particularly to a method and device for stripping or removing layers of insulation that surround bare wire.

### BACKGROUND OF THE INVENTION

Builder's wire can generally be defined as wire used to supply mains electrical power to household, commercial and industrial appliances. In most cases this will be three insulated wires which are then encased in an outer insulation layer so that the system is known as a double-insulated wire. Builder's wire by nature is a flat bundle of wires, meaning that the wires inside the sheath lay side by side and are not wrapped or twisted around one another. Sometimes it will is only be one or two wires and possibly up to four wires in some instances. The common builder's wire used in Australia is for 240 Volt single phase supply and has three core wires, being Active, Neutral and Earth (Ground). The size range for each wire in the bundle varies from 1 square mm and 1.5 square mm, which are used mostly for lighting and other light loads such as smoke alarm circuits, up to 2.5, 4.0 and 6.0 square mm, which are each used for power circuits and heavier load or current carrying applications. The square millimetres in this instance refers to the cross-sectional area of the copper contained in each bundle and is not to be confused with the diameter of the wires. The wires may be single core or stranded wire.

Currently the wire stripping process is performed manually in which the outer insulation is first cut back and then stripped away using a standard tool. Then the inner wires are separated and each of these is stripped one at a time with the tool which can be standard pliers or a hand wire stripper. Such tools are designed to strip individual wires only. The whole process can typically take 30 or 40 seconds for a skilled tradesperson. Given that the tradesperson can spend a large proportion of a day stripping wires, this will amount to a significant amount of time which could otherwise be utilized lint other tasks. Furthermore, such a repetitive task can lead to tradespeople to getting Repetitive Strain Injury (RSI). This can severely hamper a tradeperson's ability to complete a task given that it requires strength in the person's hands and arms and the person may get tired easily, which in turn leads to unsatisfactory results in jobs undertaken.

The present invention seeks to overcome the above disadvantage by reducing the amount of time spent stripping a set of wires, particularly where there is a double insulation covering involved.

Another problem, in the area of batteries and adaptors for use with power tools, is that it is difficult for a user to have one brand of power tool and another brand of battery, so that the user has to use the tool and battery (including charger) from the same manufacturer. This is a disadvantage as the user is tied to the same manufacturer and does not have the option of using an existing adaptor and battery with, for example, a new power tool, Therefore, if the tradesperson wanted to use another power tool, he/she would have to carry additional batteries and chargers which would take up space in a tool box and would each require separate charging outlets.

### SUMMARY OF THE INVENTION

According to a first aspect of the invention, there is provided a device rot stripping insulation means from a flat-bundled wire means, said device including:

a member for gripping said insulation means;

blade means for penetrating and/or weakening the insulation means at a clamping or penetrating region of the insulation means;

wherein part of the insulation means is removed by relative movement between a gripped portion of the insulation means by said member and the blade means when the blade means is in contact with the insulation means.

The flat-bundled wire means may include one or more wires and where the wire means has two or more wires, each wire in the bundle may be positioned side by side.

The device may further include means for enabling said blade means to engage and disengage from said insulation means. The blade means is preferably a pair of blades and is associated with a pair of members for supporting or otherwise controlling movement of said blade means. The means for enabling may be a first jaw assembly, said first jaw assembly including a first pair of flaws, said blade means forming part of said means for enabling.

The means for enabling is preferably adapted to close the first pair of jaws such that the blade means clamps against the insulation means at the clamping or penetrating region. The insulation means can include an inner insulation covering around each of said one or more wires and an outer insulation covering around the inner insulation covering.

The first pair of jaws preferably clamps and grips the outer insulation covering at the clamping or penetrating region such that a part of the outer insulation covering is removed by movement of a portion of the outer insulation covering away from the clamping or penetrating region and thereafter a part of the inner insulation covering is removed from one or more wires by the first pair of jaws clamping and gripping the inner insulation covering at the clamping or penetrating region with more force, by movement of a portion of the outer insulation covering and the inner insulation covering away from the clamping or penetrating region.

The member may further include a second jaw assembly including a second pair of jaws, the second jaw assembly preferably being spaced apart from the first jaw assembly and adapted to grip the insulation means and move the portion of the insulation means.

The second jaw assembly preferably grips the outer insulation covering to assist in removing the part of the outer insulation covering by movement of the outer insulation covering away from the clamping or penetrating region and to remove part of the inner insulation covering upon further movement the second jaw assembly away from the clamping or penetrating region.

The first jaw assembly preferably forms part of a first frame assembly and the second jaw assembly preferably forms part of said member and termed a second frame assembly. The second frame assembly may have linkage means for enabling movement of the second pair of jaws of the second jaw assembly by a pivoting action that allows engagement of the second pair of jaws and additional grip with the outer insulation covering, and disengagement of the second pair of jaws from the outer insulation covering.

The device may have roller means in the form of a pair of rollers that each respectively contact one of the jaws in the first pair of jaws to move the jaws towards each other and away from each other to engage and disengage the blade means with the insulation means. Each jaw in the first pair of jaws preferably has a surface that is ramped and contacts a respective roller in said pair of rollers to assist in the engagement and disengagement of the blade means with the insulation means.

Resilient means may be linked to each of the jaws in the first pair of jaws that are biased to retain the jaws in said first pair of jaws in an open position. Each pair of jaws in the second pair of jaws may have a further resilient means in contact therewith to initially move a respective jaw in said second pair of jaws into contact with the outer insulation covering, whereby additional grip is provided against the outer insulation covering through leverage from the linkage means.

One or more motors may enable movement or control of each of the blade means and the second jaw assembly. Initially the second pair of jaws is preferably brought into contact with the outer insulation covering to grip the outer insulation covering. The blade means is preferably a blade on each jaw in the first pair of jaws and each blade of each jaw is brought into contact with the outer insulation covering to grip the outer insulation covering.

The second jaw assembly and second pair of jaws are preferably moved away from the clamping or penetrating region to break the outer insulation covering and expose the inner insulation covering. The blades of each jaw in the first pair of jaws can be brought into contact with the inner insulation covering, whereby the jaws of the first pair of jaws are closer together than when each of the jaws of the first pair of jaws are clamped to or engaged with the outer insulation covering.

The second pair of jaws may be moved further away from the clamping or penetrating region of the inner insulation covering to break the inner insulation covering and expose the insulated wires. The first and second pair of jaws are preferably returned to the initial state prior to the next stripping operation. The first frame assembly may have a pair of flanges or stops against which a portion of the linkage means abuts to disengage the second pair of jaws from the insulation means.

The device may further include means for removing unwanted or discarded insulation means. The amount of and length of outer and/or inner insulation covering to be removed is preferably adjustable. The jaws in the second pair of jaws are preferably offset from one another to provide increased gripping ability against the insulation means.

According to a second aspect of the invention, there is provided a power tool having the device for stripping insulation means of the first aspect.

The power tool may further including a handle, the handle having an aperture for receiving a battery adaptor, such that any type of battery adaptor and battery can be fitted and connected to the power tool using the aperture.

The power tool may further include drive gear means for separately powering the device for stripping insulation means and a rotary device. The tool may further include indication means for displaying information to a user of die tool. The tool can have processor means and memory means linked to the indication means, wherein a series of preset programs are able to be selected and used to strip a wire or wires using the device for stripping insulation means.

According to a third aspect of the invention, there is provided a powered tool of the type having a motor for driving a rotary device, said motor being provided power from a power source, said powered tool including:
a device for stripping insulation means from a flat-bundled wire means the device including a member for gripping said insulation means; blade means for penetrating and/or weakening the insulation means at the clamping or penetrating region of the insulation means; wherein part of the insulation means is removed by relative movement between a gripped portion of the insulation means by said member and the blade means when the blade means is in contact with the insulation means; and
gear means for providing power separately to the rotary device and to the device for stripping insulation means.

The powered tool is preferably cordless and includes an aperture formed in a handle sized to receive any one of a series of portable power source adaptors linked to a corresponding portable power source.

According to a fourth aspect of the invention, there is provided a method of stripping insulation means from a flat-bundled wire means including the steps of:
providing a member for gripping said insulation means;
   providing blade means for penetrating and/or weakening the insulation means at a clamping or penetrating region of the insulation means;
removing a part of the insulation means by relative movement between a gripped portion of the insulation means and said blade means when the blade means is in contact with the insulation means.

The insulation means can be formed by an outer insulation covering and an inner insulation covering within said outer insulation covering, said inner insulation covering being around one or more wires.

The method may further include, after the outer insulation covering is clamped;
moving a portion of the outer insulation covering away from the clamping or penetrating region to remove apart of the outer insulation covering to expose the inner insulation covering;
subsequently increasing the grip on the inner insulation covering at the clamping or penetrating region and further moving the outer insulation covering and a portion of the inner insulation covering away from the clamping or penetrating region to remove a part of the inner insulation covering to expose the insulated wires.

The assembly may include a second jaw assembly having a second pair of jaws to grip against and enable movement of the outer insulation means in order to first remove a part of the outer insulation covering and then remove a part of the inner insulation covering at the clamping or penetrating region. The method may further include providing motor means to enable relative movement between said blade means and said gripped portion of the insulation means.

Initially the second pair of jaws may be brought into contact with the outer insulation covering to grip the outer insulation covering. Following the removal of a part of the outer insulation covering, the blade means can be clamped tighter against the inner insulation covering and the second pair allows may again be moved away from the clamping or penetrating region in order to weaken and break a part of the inner insulation covering to expose the insulated wires.

### BRIEF DESCRIPTION OF THE DRAWINGS

Preferred embodiments of the invention will hereinafter be described, by way of example only, with reference to the drawings in which:

FIG. 1 is a block diagram of a device for stripping insulation means from a flat-bundled wire means according to a first embodiment, showing an insulated wire means loaded into the device ready to be stripped;

FIG. 2 shows the device of FIG. 1 with a set of jaws gripping against an outer insulation covering of the insulation means;

FIG. 3 shows the device of FIG. 1 with a second pair of jaws having blade means gripping against another part of the outer insulation covering;

FIG. 4 shows the device of FIG. 1 where a frame means moves the pair of jaws and outer insulation covering away from the clamped or gripped portion to remove the outer insulation covering;

FIG. 5 shows the device of FIG. 1 where the blade means of the second pair of jaws grip further on an inner insulation covering;

FIG. 6 shows the device of FIG. 1 in which the frame means moves further away from the clamped portion of the inner insulation covering to remove the inner insulation covering to expose the bare wires;

FIG. 6A is a perspective view of the insulated wire means having both the outer and inner insulation coverings stripped away;

FIG. 7 is a block diagram of a power tool including the device of FIG. 1 positioned or a top portion of the power tool;

FIG. 8 is a graph showing the movement of stepper motors used to control a pair of frame means in the insulation stripping process;

FIG. 9 is a table showing a values of a preset program used to strip insulation from a cable.

### DETAILED DESCRIPTION OF THE PREFERRED EMBODIMENTS

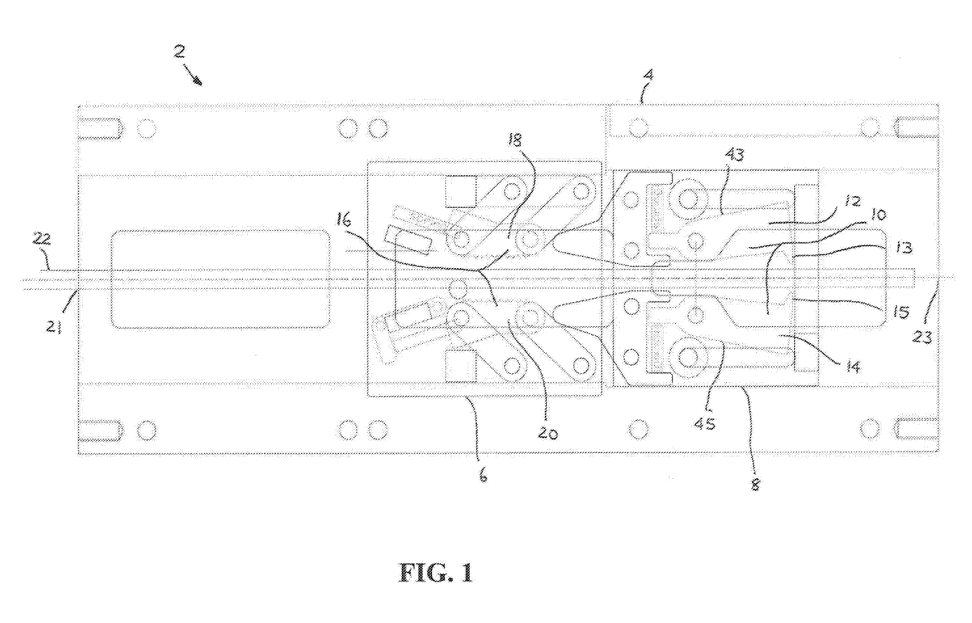

Referring to FIG. 1 there is shown a device 2 for stripping insulation means from wire in a flat-bundled wire means, the device 2 having a main frame means or assembly 4 that includes a first frame assembly and a member (later termed a second frame assembly) 8 and 6. Relative movement occurs between a blade means and a gripped portion of the insulation means by the member to strip part of the insulation means from the wire means. The first frame assembly 8 includes a first jaw assembly 10 that includes a first upper jaw 12 and a second lower jaw 14 which respectfully pivot about pivot points 25 and 24. Roller means including a pair of rollers 34 and 36 are designed to move respectively in horizontal slots 46 and 48 to act on a respective outer face 43, 45 (which is ramped compared to inner surfaces 17, 19) of each of the jaws of 12 and 14 so that the jaws 12 and 14 are brought towards each other from their normal state of rest, as shown in FIG. 1, where the jaws 12 and 14 are held open by springs 38 and 40.

The second frame assembly 6 includes a second jaw assembly 16 which further includes an upper jaw 18 and a lower jaw 20. The assembly 6 also includes linkage means in the form of a pair of links 26 and 28 on an upper side thereof and a pair of links 30 and 32 on a lower side thereof. The first pair of links 26, 28 are connected to the upper jaw 18 while the second pair of links 30, 32 an connected to the lower jaw 20. Both lower jaw 20 and upper jaw 18 form the second jaw assembly 16. Each of the jaws 18, 20, on an inner surface, have serrated edges 51, 53 for gripping cable 22 which has a double-insulation covering, termed the insulation means, including an inner insulation covering over each of the hare wires and an outer insulation covering over the inner insulation covering.

The invention may extend to having multiple sets of jaw assemblies, that is more than one set of clamping jaws 16, 18 and more than one set of cutting or penetrating jaws 12, 14. It is preferable that the clamping jaws (second jaw assembly 16) is as near to the point of penetration of blades 13, 15 of cable 22, so as to prevent stretching of the plastic material that makes up the insulation means. This gives finer control of the actual lengths of the insulation being stripped, and makes the break occur quicker as the plastic insulation reaches its breaking point faster as the percentage of plastic material being fractured is much higher than the total length of insulation being stretched.

The cable 22 has the insulation means formed around a flat-bundled wire means, where either one wire exists or two or more wires positioned side by side exist. The inner insulation covering need not cover each individual wire in the flat bundle, as for example, in the USA the earth (ground) wire is often left exposed or uninsulated. The initial rest state of the jaws 18 and 20 shown in FIG. 1 are held in position by flanges or stops 54 and 56 of bracket members and 52. The frame 6 is moved by a motor to have each of the jaws 18 and 20 contact and grip the outer insulation covering of the cable 22. Each of the links 26, 28, 30 and 32 pivot about pivot points 62, 64, 58 and 60 respectively which are each connected to the frame 6.

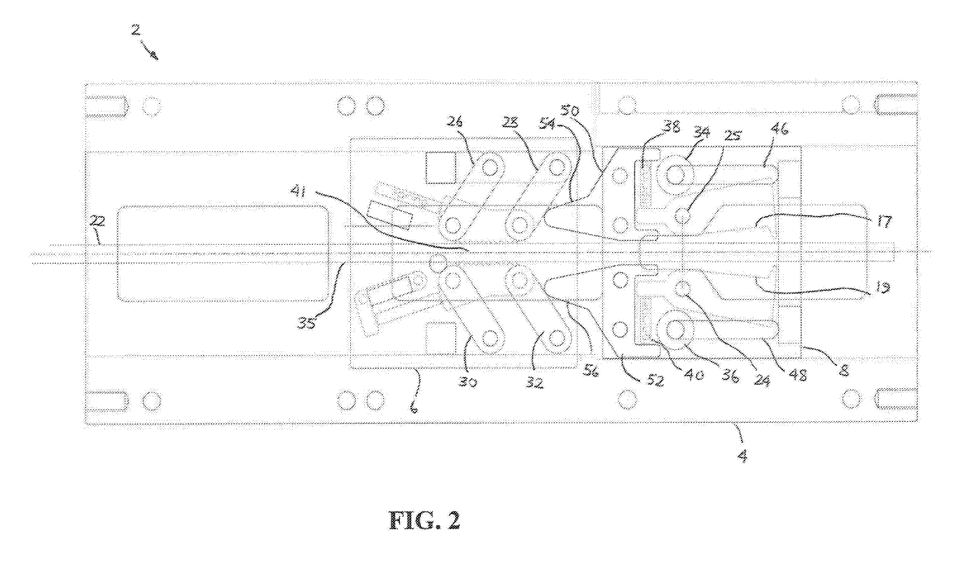

Referring to FIG. 2 the operation of the device 2 will now be described. Initially the cable 22 is inserted at opening 21 of the left side of the device 2 and is fed between the pair of jaws 18 and 20, (bracket members 50 and 52 and the pair of jaws 12 and 14). The cable 22 may typically be a three-core builder's wire which has three separate wires individually insulated side by side and then there is the second layer of insulation encapsulating the three insulated wires. There may be an adjustable stop at the right hand end 23 of the device 2 which defines the length of the outer insulation covering (and the length of the inner insulation covering) to be removed. A sensor may be placed in this position to allow the adjustable stop to sense the presence of the cable in which case the device 12 may cause the upper and lower jaws 12 and 14 to close and grip against the cable 22 at a pre-set position.

The first action, that takes place as shown in FIG. 2, is where a motor controls the movement of frame 6, whereby initially it moves away from frame 8, and this causes the links 26, 28, 30 and 32 to move the serrated jaws 18 and 20 towards one another to grip the outer insulation covering 35 at a gripped portion 41, under the action of springs 42 and 44. Thus the springs 42, 44 force the jaws 18, 20 to grip the cable 22. On the initiation of tension to each of jaws 18, 20, the more tension or force that is applied to the jaws 18, 20 the more grip each of the jaws 18, 20 applies to the outer insulation covering of cable 22. This is due to a pivoting or levering action applied though the linkage means 26, 28, 30 and 32.

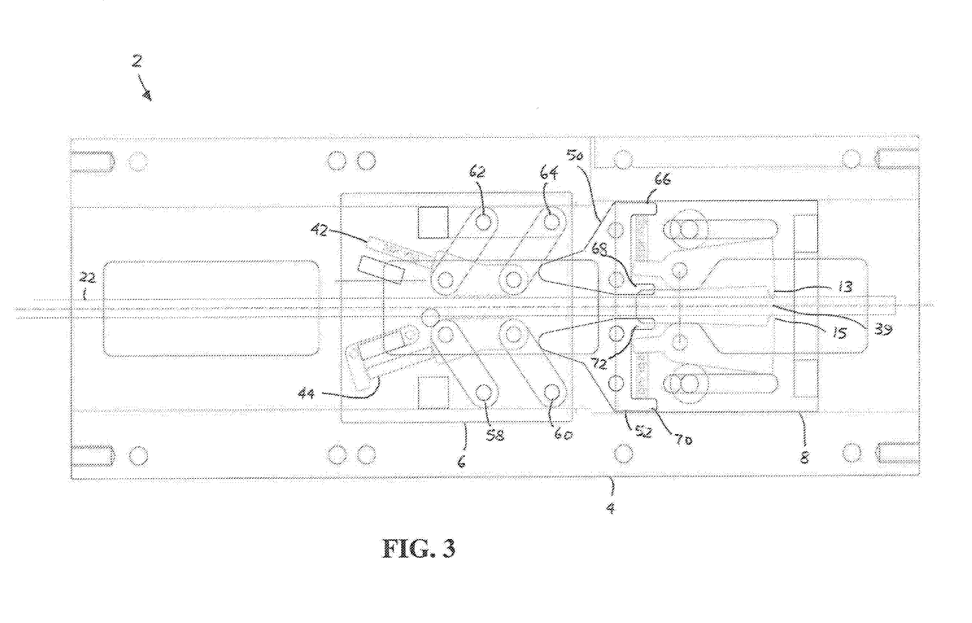

The next stage is seen in FIG. 3 whereby a separate motor is linked to and controls the movement of frame 8 such that rollers 34 and 36 move respectively within the slots 46 and 48 and have contact with an outer surface of each of the jaws 12 and 14. This forces the jaws 12 and 14 to move toward one mother so that they impinge on the outer surface of cable 22 at a clamping or penetrating region 39 as seen in FIG. 3. One single motor can drive both frames 6 and 8, for example by using a clutch mechanism, such as a dog clutch, that bring the first pair of jaws 12, 14 and blade means 13, 15 into and out of engagement with the insulation means. The movement of jaws 12 and 14 is possible as they pivot around the pivot points 25 and 24 against the action of the springs 38 and 40. The blades 13 and 15 of jaw 12 and 14 respectfully are each shaped with a small curve or flat area at the outer edge of the wedge of the blade. Each blade 13, 15 is generally flat and can be sharp or blunt, and is wedge-shaped, with either a flat area or soft/small radius to break and pull at the insulation coverings, rather than cut through the insulation with a sharp or contoured blade or knife. Each blade 13, 15 preferably extends across the whole width of each jaw 12, 14 (in the direction into the page). The height of each of the blades 13 and 15 protruding from respective surfaces 17 and 19 is ideally approximately equal to the thickness of the insulation material to be stripped. The edge of the blades 13 and 15 are used to protrude into the insulation coverings. The blades 13 and 15 art shown in FIG. 3 where they protrude into the outer insulation covering of cable 22. The blacks 13, 15 are designed to penetrate, weaken or fracture the outer and inner insulation coverings at the clamped region 39, which is where the blades 13, 15 grip the insulation means. If necessary, a further sharp blade or sharp blades can be used in conjunction with and adjacent to blades 13, 15 in order to penetrate, weaken or fracture the outer and/or inner insulation coverings where such insulation coverings are made of particularly hard material.

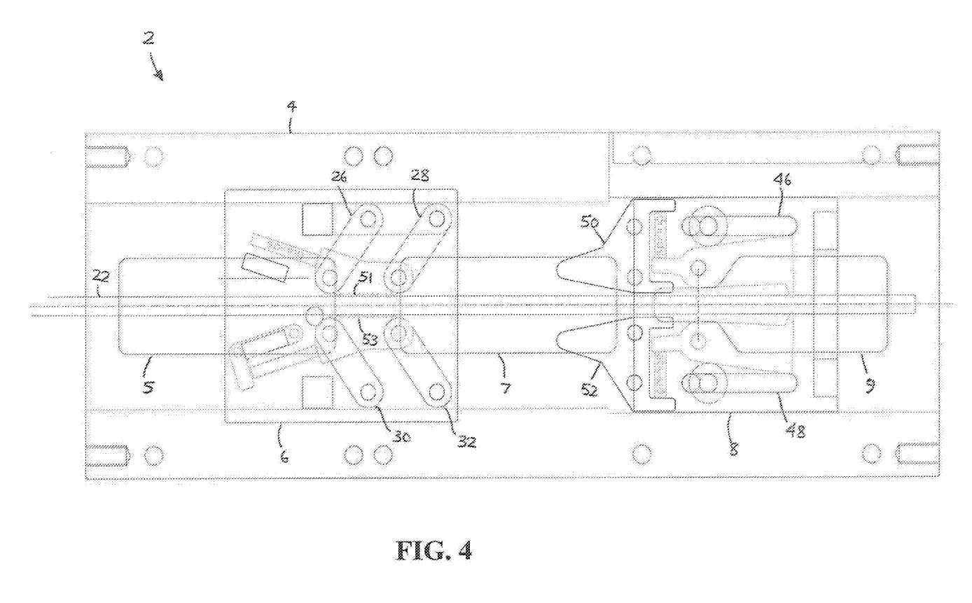

Referring to FIG. 4, with the first set of jaws 18 and 20 firmly grasping the outer insulation covering of cable 22, the motor attached or linked with frame 6 moves it further away from frame 8 which in turn stretches or pulls the outer insulation covering due to the jaws 12 and 14 remaining fixed and protruding into or penetrating and/or weakening the outer insulation covering 35. Thus, the jaws 18, 20 move together with the gripped cable 22. Equally applicable is if each of the gripping jaws 18 and 20 (or member 6) and the cutting jaws 12 and 14 both move in order to stretch and break the insulation covering. Alternatively the jaws 12 and 14 can move with respect to jaws 18 and 20 or member 6. The blades 13 and 15 are designed not to cut into the inner metal wires which avoids the effect of dragging, scraping or removing metal from the wire. Therefore no weak point is created and maximum current load rating of the wire would still apply. The process described in relation to FIG. 4 removes the outer insulation covering 35 of the cable 22. The three wires still remain side by side each having another insulation layer 27, termed the inner insulation covering. Thus, part of the insulation means is removed by relative movement between the gripped portion 41 of the insulation means and the blades 13, 15 when the blades 13, 15 are in contact with the outer insulation covering 35.

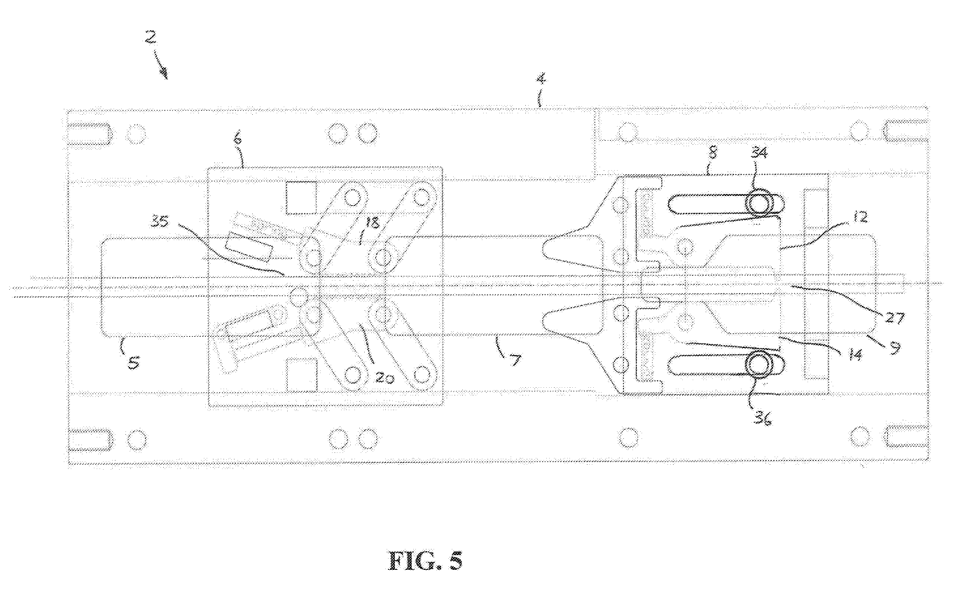

Referring to FIG. 5 the next step is the motor that moves frame 8 now moves the rollers 34 and 36 even further against the respective jaws 12 and 14. This forces each of the jaws 12 and 14 closer together so that they are just a few millimetres apart approximately just greater than the width of the bare wires. It is critical to preset, in the relevant program, the distance that the blades 13, 15 are brought closer together to grip into, penetrate or weaken the inner insulation covering 27 so as not to sever the bare wires. Thus the motor that moves the frame 8 must be set to move the preset distance, that s the distance through which, the rollers 34, 36 are forced to move within the slots 46, 48 to bring the blades 13, 15 closer together to be in a position to strip the inner insulation covering 27.

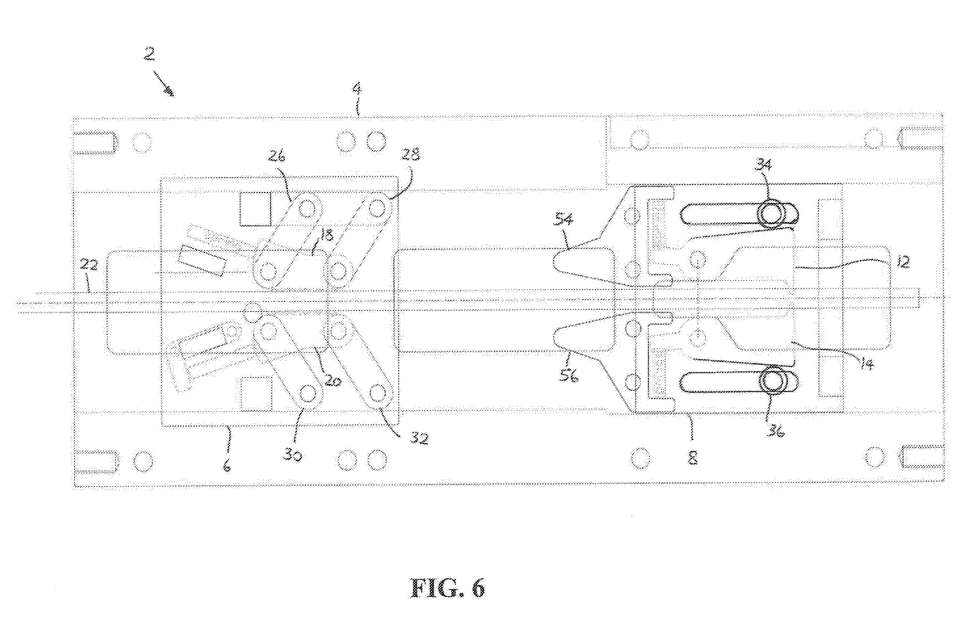

Referring to FIG. 6 the motor associated with frame 6 moves or stretches the cable 22 even further so that the effect of the stationary jaws 12 and 14 strips away the inner insulation covering of the individual wires. For ideal results, the length of the outer insulation covering that is required to be removed is between 20 mm and 90 mm and preferably between 40 mm and 70 mm, while the length of the inner insulation covering required to be removed is between 8 mm and 20 mm.

The final stage in the cycle is the motor associated with frame 6 returning to its original position as shown in FIG. 1 whereby, when the links 28 and 32 respectively abut stops 54 and 56, which prizes the jaws 18 and 20 apart from one another. At the same time the motor associated with frame 8 moves the rollers 34 and 36 to their original position within slots 46 and 48 as shown in FIG. 1. This releases the jaws 12 and 14 and separates one from the other under the action of the springs 38, 40 and it is now possible to release the cable 22 from the jaw assemblies 10 and 16 with the insulation removed twice to expose the bare wires at the right to hand end of the device 2. The time when the gripping jaws 18 and 20 open is not significant and these jaws can return to the starting position before opening to be ready for the next cycle. By opening the jaws 12 and 14 reasonably early, at a few millimetres less than the distance necessary to completely remove the insulation, the wire insulation material can remain attached to the wires and is then easily removed and these waste items discarded by hand. This prevents the small waste pieces of insulation remaining in the machine which can get jammed in the device 2 or cause a misreading by the motors (or processor controlling the motors) of a measurement of one of the stops (how far the frames 6, 8 move). Alternatively moving it 100% of the travel of the table is a further option. Means for removing the waste insulation material can be used in the device 2. Items 5, 7 and 9 are open windows through which to see other components of device 2.

FIG. 6A shows the resulting flat-bundled wire stripped twice whereby cable 22 with outer insulation, covering 35 has been stripped at point 31 by blades 13, 15 to firstly reveal the inner insulation covering 27, that originally was covered by the outer insulation covering 35. The inner insulation covering 27 is formed by three separate coverings around three respective separate wire strands 29. The inner insulation covering 27 was subsequently stripped at point 33 by blades 13, 15 to reveal the exposed wire bundles or strands 29.

In order to remove the waste insulation, a serrated pair of jaws and/or rollers can be aligned with the insulation of cable 22 at the right hand end near stop 23. The purpose of these jaws or rollers is to remove the waste insulation from inside the device 2 and discard it outside the device 2. Alternatively the waste material can be left attached to the end of the cable (right hand side) and removing it manually. As the cutting jaws 13, 15 grip and break away the outer and inner insulation coverings, the additional jaws or rollers contact the coverings and pull this away to the right externally of the device 2.

In order that the gripping jaws 18 and 20 can grip the outer insulation covering in a way so as to prevent them from sliding along an inner insulation, around the bare wires, the jaws may be offset from one another so that a gripping area on the lower jaw 20 passes the line of the upper jaw 18 causing the entire cable to kink slightly. The kink can cause the insulation to bind on the inner wires and not slide. Alternatively, the cable can be kinked or have additional friction points whereby one or more rods protrude from either or both jaws 18, 20 into corresponding recesses or in the outer covering of the cable insulation to stop any sliding movement. Another solution to the problem of the outer insulation covering sliding over the inner insulation covering is to have a third pair of jaws, similar to the gripping jaws of jaws 18 and 20. The third set of jaws could move into position when enough of the inner insulation covering was exposed (after the outer insulation covering is removed) and then either both sets of jaws (the third pair and jaws 18, 20) or just the additional third set of jaws, grip and pull off the inner insulation covering to expose the wires.

The blades 13 and 15 of jaws 12 and 14 can sever the outer and inner insulation coverings so that the coverings are fractured and then pulled away from the cutting blades along the fracture point. In addition to this, a further sharp blade or knife that has travel limited by the position of the blades 13, 15 can work separately or in tandem with blades 13, 15 to sever the sheaths or insulation coverings more positively.

The device 2 can be made adjustable or be pre-set for the size of the outer casing of the wires in either width or height or both. It may also be adjustable or pre-set for the length of the outer insulation to be removed and for the length of the insulation to be stripped from the inner wires, either as a group or for each individual wire.

Due to the possibility of wear in the components and other variations such as temperature, the difference between manufacturers or other criteria, there may be a need to make further slight adjustments to the manner in which the wire is clamped and how the insulation is cut or broken. The device can be either mechanically driven or power driven. The above description has been based on the mechanically driven version, however with the power driven version such a device, may be attached to a power tool to assist in quickly stripping insulation from wires on a particular site or job. For example a portable hand held tool can incorporate a wire stripping device 2 described above. Such a tool could be used after a set of insulated wires, have been “roughed in” to a building site. This essentially means that wires have been installed into walls or partitions but are yet to be connected to an outlet or switch for the first time. Generally these insulated wires are excessive in length and have previously been cut using a pair of pliers which does not always result in a neat and tidy cut.

Ideally the cutting blades 13, 15 and the second pair of jaws 18, 20 gripping the outer insulation covering are as close as possible to each other to save on space and also to minimize the amount of stretching over a short distance in the insulation material (usually plastics material) prior to its breaking or fracturing. The blade means 13, 15 need not be part of jaws 12, 14 respectively, but can be independent and controlled to engage and disengage from the insulations means, outer and inner coverings under the action of for example, a motor. The blades 13, 15 also need not be carried or supported in a frame assembly 8. The blades can be configured to simply move towards each other to cut the insulation and away from each other when not in use. Any waste insulation material that has been cut away during the process can be removed by the blades 13, 15 where the blades sweep the unwanted insulation away from the device 2, for example beyond end 23.

The system can have a torque multiplication link (or a linkage torque multiplier), whereby when the motor controlling frame 6 pulls the frame 6 to stretch the cable 22 and the load becomes too great, some springs are overcome, and leverage is produced which multiplies the power by a factor of three while the speed of travel of the cable 22 being stretched is slowed by a factor of one third. This occurs for a temporary period just prior to the outer insulation covering 35 breaking. When the outer it covering 35 breaks, the frame flicks back slightly but continues to travel. Thus a large motor is not required to perform the same task.

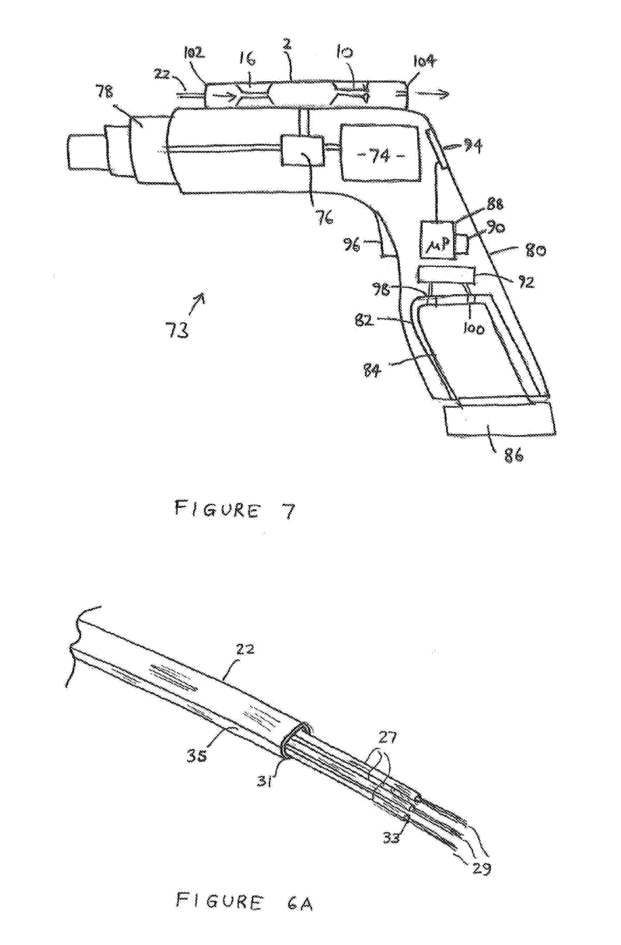

Referring to FIG. 7 there is shown a powered tool 73 in the form of a cordless drill, having a handle 80, rotary device in the form of a chuck 78 (far a drill or screwdriver), trigger or switch 96 and motor 74. The powered tool may be supplied with mains power instead of a battery, as the power source. Attached to the top of the tool 73 is an example of a wire stripping device 2 which has a size that is compatible to the size of the tool 73. Preferably the jaw assemblies 10 and 16 are close together so that there is less cable length required to be stretched in order to remove the outer and inner insulation coverings. A more compact wire stripping device is used. The device 2 can be attached to any other suitably used power tool. A clutch mechanism or gearbox 76 (gear means) may be driven by the motor 74 to independently provide power to the device 2 and also to the chuck 78. Thus motor 74 can selectively drive chuck 78 and each of the frames 6, 8 of the device 2.

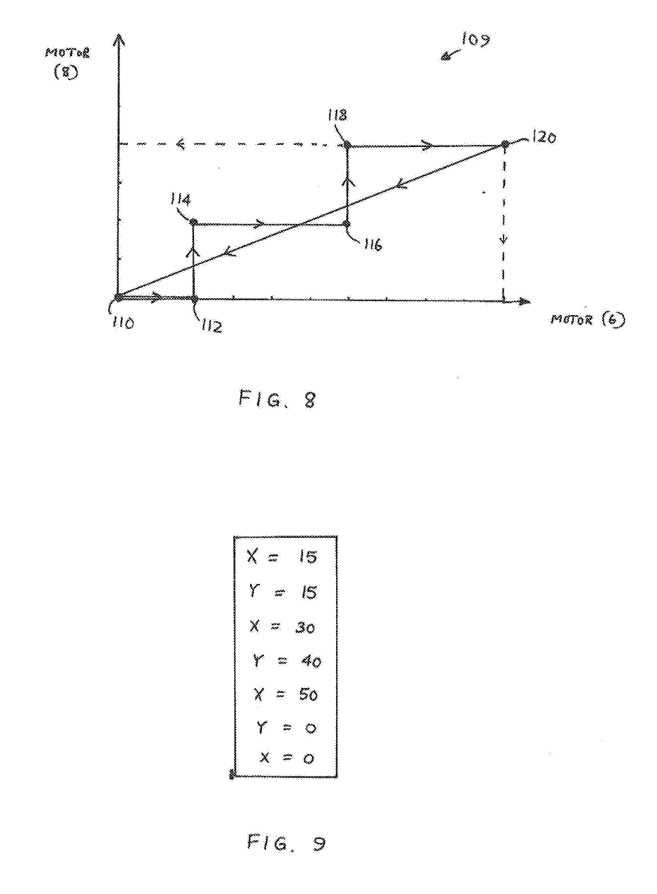

At the lower end of handle 80 there is located an aperture 82 which has electrical connection points 98 and 100 to an electrical circuit 92 which in turn is connected to motor 74 and microprocessor 88. A memory 90 is associated with the microprocessor 88 and an indication means 94, which is this embodiment is a screen, is connected to the microprocessor 88 for use and interaction by a user of the device 73. The indication means may be visible (such as LEDs) or audible where a user can use a series of buttons to select one of a number preset programs for a particular task (described in relation to FIGS. 8, 9 hereinafter) or use “+” and “−” buttons on the actual task at hand to increase or decrease a particular desired parameter, such as increasing/decreasing the amount of grip from the jaws or increasing/decreasing the depth of the cutting blade in, the outer and/or inner insulation coverings. After using “+” and “−” buttons on a live task, the user can save a particular setting to memory 90. The need for a user to change the settings on a live job may be in response to the type of material used for the insulation, the behaviour of the plastics material of the insulation under stress, for example, or temperature and humidity variations. There are generally at least four variables (to control movement of the motor or motors controlling movement of each pair of jaws) for a tradesperson to alter or use on a job of wire stripping: the amount of grip applied to the outer insulation covering through the second jaw assembly 16; the depth of the blades 13, 15 that cut into each of the outer and inner insulation coverings; the length of the outer insulation covering to be stripped and the length of the inner insulation covering to be stripped. Each of these settings can be programmed and as many as 15-20 preset programs can be provided and stored in memory 90.

The aperture 82 is designed to fit a battery adaptor of any particular manufacturer which can provide power from a battery 86 to the rest of the device 73. Thus any sized adaptor 84 can fit into the aperture 82 with its associated battery 86 and connect to the connection points 98, 100. The tool or device 73 can therefore be used with any particular type of battery of another manufacturer by using the adaptor 84.

On a site or a job that requires many electrical installations, a user can use the device 73 in the usual manner but also in combination with a wire stripping device 2 whereby table 22 is inserted at one end 102 in order to strip the insulation coverings from the wire or wires. Any waste insulation from the outer and inner insulation coverings are sent through the other opposite end 104 of the device 2 and dispensed elsewhere by the user. This therefore saves a lot of time, from the perspective of the user, who requires the use of a power tool but, also the ability to use any particular battery with its associated adaptor and to use a much more efficient and quicker wire stripping device 2.

The tool 73 may include within the wire stripping device 2 a current detection device or voltage sensor that disables the tool if voltage or current is detected in the wires/cables about to be stripped. For operator safety, the current voltage detection is always ON.

Referring to FIG. 8 there is shown a graph 109 of the steps through which each of the motors attached to frames 6 and 8 go through. On the X-axis is the movement of a first motor associated with the frame 6 while on the Y-axis there is shown movement of a second motor associated with frame 8. The starting point is the origin at point 110 and then the motor associated with frame 6 moves the jaws 1 and 20 towards each other so they grip the outer insulation covering of cable 22, the motion going to point 112 on the graph 109. In order to get to the next point 114 on the graph 109, the motor associated with frame 8 moves the jaws 12 and 14, through rollers 34, 36 toward one another to make the respective blades to grip the other end of the outer casing of cable 22. Next, the motor associated with frame 6 moves the frame away from frame 8 so that the outer insulation covering is stretched and is eventually pulled off or away from the inner insulation covering of the bare wires. This moves along the X-axis up to point 116. The next point at 118 is achieved by movement of frame 8 whereby the rollers 34 and 36 are moved against the outer surfaces of the jaws 12 and 14 to further grip into the inner insulation covering surrounding the bare wires. The next point 120 is reached through the motor moving frame 6 so that the inner insulation covering is stretched further and eventually disintegrates to leave the bare wires protruding from the jaws 12 and 14. The process then finishes by the return to the origin point 110 of both frames 6 and 8 being moved by the respective motors to their original positions as shown in FIG. 1. The resultant movement of both motors is shown as a single diagonal line from point 120 to point 110 and individually by dotted lines to the respective X and Y axes.

With reference to FIG. 9 there is shown one type of program 122 that can be installed in memory 90 of the device 73 and be accessible by a user through the indication means 94 which may include a touch panel or buttons to select a program. Each of the X and Y values show a movement or step undertaken by the stepper motors, controlling the frames 6 and 8, of varying lengths or time. Thus a series of programs with pre-set positions or movements associated with the motors can be selected. An operator can adjust or use a pre-set program, for example dependent on the brand of the wire, or the stripping circumstance that is required or dependent on the hardness of the insulation casing. It is also possible to erase or delete a preset program due to one preset function being better than the deleted one or one preset function being almost exactly the same as another preset function, to avoid confusion on the part of the user. A list of most used presets or programs can be accessible easily by the user, identified by a name or a number, for example.

Each of the motors are stepper motors and together undergo seven stages in this embodiment. Alternatively other motors, such as servo motors, can be used provided that the position of each of the frames 6, 8 can be determined. A program can be set up to change any of the lengths of wires to be stripped, in other words, the distance that the cable moves through. It eat also be set as to how long a pair of jaw is to grip on to the cable, how far the jaws go in and grip the cable or cables, how far to strip the outer insulation covering, how far to close the jaws for the stripping of the inner insulation covering around the bare wires and how far to travel in order to strip the end part, that is, the length of the bare wires.

1-42. (canceled)

43. A battery-powered handheld tool of the type having a motor for driving a rotary device, said powered tool comprising:
a device for stripping insulation from a flat-bundled wire, the device comprising a member for gripping said insulation, and at least one blade for penetrating and/or weakening the insulation at a clamping or penetrating region of the insulation;
wherein part of the insulation is removed by relative movement between a gripped portion of the insulation by said member and said at least one blade when said at least one blade is in contact with the insulation;
wherein the insulation further comprises an inner insulation covering around each wire in said flat-bundled wire and an outer insulation covering around the inner insulation covering; and
wherein said device for stripping said insulation removes part of the outer insulation covering and then part of the inner insulation covering.

44. A tool according to claim 43 further comprising a gear for providing power separately to the rotary device and to the device for stripping insulation.

45. A tool according to claim 44 wherein said gear is driven by said motor to independently provide power to the stripping device and to a chuck of the rotary device in order to selectively drive the chuck and the stripping device.

46. A tool according to claim 43 that is cordless and comprises an aperture formed in a handle sized to receive any one of a series of portable power source adaptors linked to a corresponding portable power source.

47. A tool according to claim 43 wherein said flat-bundled wire comprises one or more wires and when the flat-bundled wire comprises two or more wires each wire in the bundle is positioned side by side.

48. A tool according to claim 43 wherein said device further comprises a device for enabling said at least one blade to engage and disengage from said insulation.

49. A tool according to claim 43 wherein said at least one blade is a pair of blades and is associated with a pair of members for supporting or otherwise controlling movement of said pair of blades.

50. A tool according to claim 48 wherein said device for enabling is a first jaw assembly, said first jaw assembly comprising a first pair of jaws, said at least one blade forming part of said device for enabling.

51. A tool according to claim 50 wherein said device for enabling is adapted to close the first pair of jaws such that said at least one blade clamps against the insulation at the clamping or penetrating region.

52. A tool according to claim 51 wherein said first pair of jaws clamps and grips the outer insulation covering at the clamping or penetrating region such that a part of the outer insulation covering is removed by movement of a portion of the outer insulation covering away from the clamping or penetrating region and thereafter a part of the inner insulation covering is removed from one or more wires by the first pair of jaws clamping and gripping the inner insulation covering at the clamping or penetrating region such that the pair of blades close toward one another to a separated distance to match the dimensions of the one or more wires, by movement of a portion of the outer insulation covering and the inner insulation covering away from the clamping or penetrating region.

53. A tool according to claim 50 wherein said member comprises a second jaw assembly comprising a second pair of jaws, said second jaw assembly spaced apart from said first jaw assembly and adapted to grip said insulation and move said portion of said insulation.

54. A tool according to claim 53 wherein said second jaw assembly grips the outer insulation covering to assist in removing said part of said outer insulation covering by movement of said outer insulation covering away from the clamping or penetrating region and to remove part of said inner insulation covering upon further movement of said second jaw assembly away from the clamping or penetrating region.

55. A tool according to claim 51 wherein said first jaw assembly forms part of a first frame assembly and said second jaw assembly forms part of said member and termed a second frame assembly.

56. A tool according to claim 55 wherein the second frame assembly comprises a linkage for enabling movement of the second pair of jaws of the second jaw assembly by a pivoting action that allows engagement of the second pair of jaws and additional grip with the outer insulation covering and disengagement of the second pair of jaws from the outer insulation covering.

57. A tool according to claim 56 further comprising a pair of rollers that each respectively contact one of the jaws in the first pair of jaws to move the jaws towards each other and away from each other to engage and disengage said at least one blade with the insulation.

58. A tool according to claim 57 wherein each jaw in said first pair of jaws comprises a surface that is ramped and that contacts a respective roller in said pair of rollers to assist in the engagement and disengagement of said at least one blade with the insulation.

59. A tool according to claim 58 wherein a first resilient component is linked to each of the jaws in said first pair of jaws that are biased to retain the jaws in said first pair of jaws in an open position.

60. A tool according to claim 59 wherein each pair of jaws in said second pair of jaws comprises a second resilient component in contact therewith to initially move a respective jaw in said second pair of jaws into contact with the outer insulation covering, whereby additional grip is provided against the outer insulation covering through leverage from said linkage.

61. A tool according to claim 60 wherein initially the second pair of jaws is brought into contact with the outer insulation covering to grip the outer insulation covering.

62. A tool according to claim 61 wherein said at least one blade comprises a blade on each jaw in said first pair of jaws and each blade of each jaw is brought into contact with the outer insulation covering to grip the outer insulation covering.

63. A tool according to claim 62 wherein said second jaw assembly and said second pair of jaws are moved away from the clamping or penetrating region to break the outer insulation covering and expose the inner insulation covering.

64. A tool according to claim 63 wherein further the blade of each jaw in the first pair of jaws are brought into contact with the inner insulation covering, whereby the jaws of the first pair of jaws are closer together than when each of the jaws of the first pair of jaws are clamped to or engaged with the outer insulation covering.

65. A tool according to claim 64 wherein the second pair of jaws are moved further away from the clamping or penetrating region of the inner insulation covering to break the inner insulation covering and expose the insulated wires.

66. A tool according to claim 65 wherein the first and second pair of jaws are returned to the open position prior to the next wire stripping operation.

67. A tool according to claim 43 wherein the amount of and length of insulation covering to be removed is adjustable.

68. A tool according to claim 66 wherein the jaws in said second pair of jaws are offset from one another to provide increased gripping ability against the insulation.

69. A tool according to claim 43 further comprising a handle, said handle having an aperture for receiving a battery adaptor, such that any type of battery adaptor and battery can be fitted and connected to the power tool using said aperture.

70. A tool according to claim 43 further comprising a display for presenting information to a user of the tool.

71. A tool according to claim 70 further comprising a processor and a memory device linked to said display, wherein a series of preset programs are able to be selected and used to strip a wire or wires using the device for stripping insulation.

72. A method of stripping insulation from a flat-bundled wire using a battery-powered handheld tool of the type having a motor for driving a rotary device, wherein said insulation comprises an inner insulation covering around each wire in said flat-bundled wire and an outer insulation covering around the inner insulation covering, said method comprising the steps of:
providing a member for gripping said insulation;
providing a blade for penetrating and/or weakening the insulation at a clamping or penetrating region of the insulation;
removing a part of the insulation by relative movement between a gripped portion of the insulation and said blade when the blade is in contact with the insulation; and
removing part of the outer insulation covering and then part of the inner insulation covering.
